(19) United States
(12) Patent Application Publication
(10) Pub. No.: US 2007/0046402 A1
(43) Pub. Date: Mar. 1, 2007

(54) Planar dielectric line, high-frequency active circuit, and transmitter-receiver

(75) Inventors: Kazutaka Mukaiyama, KYOTO-FU (JP); Shigeyuki Mikami, Hachioji-shi (JP); Koichi Sakamoto, Otsu-shi (JP); Yohei Ishikawa, Yokohama-shi (JP)

Correspondence Address: DICKSTEIN SHAPIRO LLP, 1177 AVENUE OF THE AMERICAS (6TH AVENUE), NEW YORK, NY, 10036-2714, US

(73) Assignee: MURATA MANUFACTURING CO., LTD., KYOTO-FU (JP)

(21) Appl. No.: 10/568,187

(22) PCT Filed: Jul. 29, 2004
(86) PCT No.: PCT/JP04/10829

§ 371 Date: Sep. 26, 2006

(30) Foreign Application Priority Data
Aug. 22, 2003 (JP) 2003-299008

(51) Int. Cl. H01P 3/08

(52) U.S. Cl. 333/238; 333/247

(57) ABSTRACT

A planar dielectric line having a first slot sandwiched between first and second electrodes is provided on a surface of a dielectric substrate. A second slot is positioned so as to face the first slot and is sandwiched between third and fourth electrodes on the rear face of the dielectric substrate. The width of the first slot is narrower than the width of the second slot so that the electromagnetic field energy of a high-frequency signal is concentrated in the first slot.

### FIELD OF THE INVENTION

The present invention relates to a planar dielectric line for transmitting a high-frequency signal of microwaves, millimeter waves, etc., and to a high-frequency active circuit and a transmitter-receiver constituted by using the planar dielectric line.

### BACKGROUND OF THE INVENTION

Generally, a planar dielectric line according to a related art includes on the front surface of a dielectric substrate, first and second electrodes facing each other with a fixed space therebetween such that a first slot is provided between the first and second electrodes, and, on the rear face of the dielectric substrate, third and fourth electrodes facing each other with a fixed space therebetween are formed such that a second slot sandwiched between the third and fourth electrodes and disposed at a location opposite to the first slot is provided (for example, see Patent Document 1). In such a related art, the total reflection of a high-frequency signal is repeated between the first and second slots and the signal is propagated along the first and second slots inside the dielectric substrate.

Furthermore, as another related art, a slot line is connected to the above-described planar dielectric line and electronic parts of a resistor, field-effect transistor (FET), etc., are connected to the slot line (for example, see Patent Document 2).

Patent Document 1: Japanese Unexamined Patent Application Publication No. 8-265007

Patent Document 2: Japanese Unexamined Patent Application Publication No.10-242717

In the related art of Patent Document 1, when a high-frequency signal is propagated along the first and second slots, since the high-frequency signal is concentrated inside the dielectric substrate and its vicinity and propagated, the propagation loss can be reduced. However, in case of the planar dielectric line and in case of the input-output portions of the electronic part based on the related art, the electromagnetic field distributions are different from each other. The high-frequency signal is concentrated inside the dielectric substrate within the planar dielectric line, but the high-frequency signal is present outside the dielectric substrate in case of the input-output portion of the electronic part. Accordingly, when an electronic part is mounted on a planar dielectric line based on the related art, there is a problem in that the connection loss between them increases.

Furthermore, when an electronic part is mounted only on the front surface of a dielectric substrate, the electronic part cannot be coupled to an electric field on the rear face of the dielectric substrate and accordingly, there is a problem in that the connection loss increases.

On the other hand, in the related art of Patent Document 2, since a planar dielectric line is connected to an electronic part after the planar dielectric line has been converted to a slot line, the connection loss can be reduced. However, a line conversion conductor pattern is needed for mode conversion between the planar dielectric line and the slot line and, when the line conversion conductor pattern is included, there is a problem in that the portion for mounting an electronic part (mounting portion) increases in size. Furthermore, in the related art of Patent Document 2, in addition to the small degree of freedom of the electrode pattern of a mountable electronic part, there is a tendency that the degree of freedom of the line electrode pattern around the mounting portion of an electronic part is also small.

Moreover, in the related art of Patent Document 2, since electrodes are formed on the rear face of a portion in which electronic parts are mounted on the dielectric substrate, an electromagnetic wave of an unwanted mode (a parallel plate mode) spreading to the inside of the dielectric substrate from the neighborhood of the electronic parts is easily generated and the connection loss due to the unwanted mode increases, and accordingly, there is a problem in that the interference of the unwanted mode to the other lines, etc., occurs.

### SUMMARY OF THE INVENTION

The present invention has been made in consideration of the above-described problems of the related art and it is an object of the present invention to provide a planar dielectric line, a high-frequency active circuit, and a transmitter-receiver in which the electromagnetic field energy of a high-frequency signal is concentrated on one surface side of a dielectric substrate and the loss when the planar dielectric line is connected to electronic parts, etc., can be reduced.

In order to solve the above-described problems, in the present invention, a planar dielectric line comprises a dielectric substrate; first and second electrodes formed on the front surface of the dielectric substrate so as to face each other with a fixed space therebetween; a first slot sandwiched between the first and second electrodes; third and fourth electrodes formed on the rear face of the dielectric substrate so as to face each other with a fixed space therebetween; and a second slot sandwiched between the third and fourth electrodes and disposed so as to face the first slot. In the planar dielectric line where a high-frequency signal is propagated along the first and second slots, the width dimensions of the first and second slots are set to be different from each other.

According to the present invention, since the widths of the first and second slots are set to be different from each other, the electromagnetic energy of a high-frequency signal can be concentrated in the slot having a narrower width. Accordingly, the connection loss between a planar dielectric line and an electronic part can be reduced by disposing the electronic part on the slot side having a narrower width. Furthermore, since the widths of the first and second slots are set to be different from each other, the degree of freedom of designing each slot can be increased in comparison with the case where the widths of two slots are set at the same value as in the related art.

In this case, it is desirable that, when the relative dielectric constant εr of the dielectric substrate is 20 or more and the wavelength of a high-frequency signal in the dielectric substrate is represented by λg0, the thickness dimension of the dielectric substrate be substantially in the range of 0.3 to 0.4 λg0, the width dimension of one of the first and second slots be λg0/100 or less, and the width dimension of the other be set to be substantially λg0/10.

When constructed in this way, 80% or more of the electromagnetic field energy of a high-frequency signal is concentrated on the slot side having a narrow width of λg0/100 or less and the leakage loss of a parallel plate mode, that is, the leakage loss caused by a parallel plate mode can be reduced.

In the present invention, an electronic part may be connected to the slot having a narrower width of the first and second slots.

Thus, the matching between a planar dielectric line and an electronic part is improved and the connection loss can be reduced. Furthermore, since the electronic part may be disposed so as to bridge the slot having a narrower width, in comparison with the case where an electronic part is connected to both surfaces of a dielectric substrate, the degree of freedom of designing the connection electrode patterns of an electronic part can be increased and also the degree of freedom of designing the first to fourth electrodes on the dielectric substrate can be increased.

Furthermore, since the line conversion for connecting an electronic part is not performed, the portion where an electronic part is connected can be reduced in size. Moreover, also in the portion where an electronic part is connected, since the first and second slots face each other with a dielectric substrate sandwiched therebetween, the occurrence of an unwanted mode (a parallel plate mode) can be suppressed inside the dielectric substrate in comparison with the case where an electronic part is connected to a slot line provided on one surface thereof and the other surface thereof facing the slot line is entirely covered by an electrode as in the related art, and the leakage loss of the unwanted mode can be reduced.

In the present invention, a planar dielectric line further comprises a third slot positioned on one end of the first slot and sandwiched between the first and second electrodes, and a fourth slot positioned on one end of the second slot, sandwiched between the third and fourth electrodes, facing the third slot, and having the same width dimension as the third slot, both provided on the dielectric substrate. In the planar dielectric line, the first and third slots are connected by using a first connection slot, the second and fourth slots are connected by using a second connection slot, and at least one of the first and second connection slots is constituted by a tapered slot the width dimension of which gradually changes.

According to the present invention, a vertically symmetrical transmission line made of third and fourth slots having the same width is connected to a vertically asymmetrical transmission line made of first and second slots having different widths from each other, the connection and matching to an electronic part can be improved by using the vertically asymmetrical transmission line and the transmission loss of a high-frequency signal can be reduced by using the vertically symmetrical transmission line. Furthermore, since the vertically asymmetrical transmission line and the vertically symmetrical transmission line are connected with by using a tapered slot, the insertion loss between those can be reduced.

In this case, it is desirable that, when the wavelength of a high-frequency signal being propagated along the first and second slots is represented by λg, the line length of the tapered slot be set to be substantially in the range of λg/4 to λg/2.

Thus, since the line length of the tapered slot has been set to be substantially between λg/4 and λg/2, the line length of the tapered slot is shortened and the insertion loss can be reduced.

Furthermore, in the present invention, a planar dielectric line further comprises a third slot positioned on one end of the first slot and sandwiched between the first and second electrodes, and a fourth slot positioned on one end of the second slot, sandwiched between the third and fourth electrodes, facing the third slot, and having the same width dimension as the third slot, both provided on the dielectric substrate. In the planar dielectric line, the first and third slots are directly connected and the second and fourth slots are directly connected to form an impedance matching circuit.

According to the present invention, a vertically symmetrical transmission line made of third and fourth slots having the same width is connected to a vertically asymmetrical transmission line made of first and second slots having different widths from each other, the connection and matching to an electronic part can be improved by using the vertically asymmetrical transmission line and the transmission loss of a high-frequency signal can be reduced by using the vertically symmetrical transmission line.

Furthermore, when an electronic part is connected to the vertically asymmetrical transmission line, for example, by setting the line length from the connection point where the vertically asymmetrical transmission line and the vertically symmetrical transmission line is connected, to the electronic part at one fourth of the wavelength of a high-frequency signal, a λg/4 impedance matching circuit can be constituted between the vertically symmetrical transmission line and the electronic part. Because of this, by busing the λg/4 impedance matching circuit, the insertion loss between the vertically asymmetrical transmission line and the vertically symmetrical transmission line is reduced and the matching to the electronic part can be improved. Furthermore, in comparison with the case in which, as in the related art, a vertically symmetrical transmission line is connected to a slot line through a line conversion conductor pattern and an electronic part is connected to the slot line, it is not required to use a complicated line conversion conductor pattern and the distance between a vertically symmetrical transmission line and an electronic part can be shortened to perform reduction in size.

Furthermore, in the present invention, in at least one of the first and second electrodes and the third and fourth electrodes, a planar-type band-stop filter may be provided around the first and second slots.

In this case, since the widths of the first and second slots are different from each other, there is a tendency that an electromagnetic wave of a parallel plate mode (an unwanted mode) is generated inside the dielectric substrate. According to the present invention, since a planar-type band-stop filter is provided around the first and second slots, it is able to prevent a parallel plate mode from spreading from the first and second slots and the leakage loss of a parallel plate mode can be suppressed. As a result, since the leakage of a parallel plate mode in the line width direction is suppressed and the electromagnetic field energy of a high-frequency signal can be concentrated around the first and second slots, even if a plurality of lines are provided closed to each other, an unwanted electromagnetic interference between the lines is reduced and the reliability can be increased.

Furthermore, a high-frequency active circuit may be constituted by using a planar dielectric line of the present invention. Thus, the matching to an electronic part, such as a resistor, FET, is improved, and the gain and output power can be increased. Furthermore, since the connection to a resonator through a vertically symmetrical transmission line can be performed, the load Q (QL) of a resonance circuit is improved and phase noise can be reduced. Moreover, since it is enough to dispose the electronic part so as to bridge a slot having a narrower width, in comparison with the case where an electronic part is connected to electrodes on both surfaces of a dielectric substrate, the degree of freedom of designing the connection electrode patterns of an electronic part can be increased.

Moreover, a transmitter-receiver may be constituted by using a planar dielectric line of the present invention. Thus, a planar dielectric line is connected to various electronic parts with good matching, the loss of the whole transmitter-receiver is reduced, the power efficiency is increased to reduce power consumption, and the communication quality can be improved.

### BRIEF DESCRIPTION OF THE DRAWINGS

FIG. 1 is a perspective view showing a vertically asymmetrical transmission line according to a first embodiment.

FIG. 2 is an enlarged sectional view showing first and second slots in FIG. 1.

FIG. 3 is a graph showing the relation between the width dimension of the first slot in FIG. 1 and the transmission loss.

FIG. 4 is a graph showing the relation between the width dimension of the first slot in FIG. 1 and the effective relative dielectric constant.

FIG. 5 is a graph showing the relation between the ratio of the current amount on the surface portion to the total current amount and the width dimension of the first slot in FIG. 1.

FIG. 6 is a graph showing the relation between the leakage loss of a parallel plate mode and the width dimension of the second slot in FIG. 1.

FIG. 7 is a graph showing the relation between the leakage loss of a parallel plate mode and the thickness dimension of the dielectric substrate in FIG. 1.

FIG. 8 is a graph showing the relation between the leakage loss of a parallel plate mode and the relative dielectric constant of the dielectric substrate in FIG. 1.

FIG. 9 is a perspective view showing a vertically asymmetrical transmission line according to a second embodiment.

FIG. 10 is an enlarged top view showing the essential part of an electronic part, etc., in FIG. 9.

FIG. 11 is a perspective view showing a vertically asymmetrical transmission line, a vertically symmetrical transmission line, and a connection line according to a third embodiment.

FIG. 12 is a top view showing the vertically asymmetrical transmission line, the vertically symmetrical transmission line, and the connection line according to the third embodiment.

FIG. 13 is a graph showing the relation between the insertion loss and the line length of the connection line in FIG. 11.

FIG. 14 is a graph showing the relation between the leakage loss of a parallel plate mode and the line length of the connection line in FIG. 11.

FIG. 15 is a perspective view showing a vertically asymmetrical transmission line, a vertically symmetrical transmission line, and a connection line according to a fourth embodiment.

FIG. 16 is a top view showing the vertically asymmetrical transmission line, the vertically symmetrical transmission line, and the connection line according to the fourth embodiment.

FIG. 17 is a sectional view showing a vertically asymmetrical transmission line, etc., according to a fifth embodiment.

FIG. 18 is an exploded perspective view showing an oscillation circuit according to a sixth embodiment.

FIG. 19 is a top view showing only the dielectric substrate shown in FIG. 18.

FIG. 20 is a bottom view showing only the dielectric substrate shown in FIG. 18.

FIG. 21 is an enlarged top view showing essential parts, that is, a FET and others, in FIG. 18.

FIG. 22 is a block diagram showing a communication device according to a seventh embodiment.

### REFERENCE NUMERALS

1 and 56 vertically asymmetrical transmission lines

2 dielectric substrate

2A surface

2B rear face

3A first electrode

3B second electrode

4 and 56A first slots

5A third electrode

5B fourth electrode

6 and 56B second slots

11, 34, and 41 electronic parts

21, 31, 55, and 77 vertically symmetrical transmission lines

22, 32, and 55A third slots

23, 33, and 55B fourth slots

24 and 57 connection lines

25 and 57A tapered slots

26 and 57B connection slots

35 λg/4 impedance matching circuit

42 and 60 planar-type band-stop filters

51 oscillation circuit (high-frequency active circuit)

52 dielectric resonator

53 electrode (first or second electrode)

54 electrode (third or fourth electrode)

58 FET (electronic part)

59 terminating resistor (electronic part)

61 communication device (transmitter-receiver)

63 high-frequency active circuit

67, 70, 72, and 75 amplifiers (electronic parts)

68 and 73 mixers (electronic parts)

### DETAILED DESCRIPTION OF THE INVENTION

Planar dielectric lines and a transmitter-receiver according to embodiments of the present invention are hereinafter described with reference to the accompanied drawings.

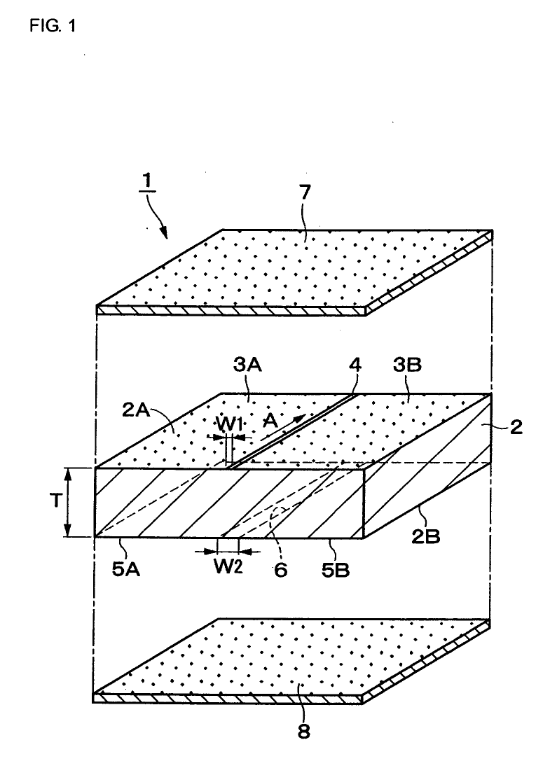

FIGS. 1 to 8 show a first embodiment. In the drawings, reference numeral 1 represents a vertically asymmetrical transmission line, and the vertically asymmetrical transmission line 1 is composed of a dielectric substrate 2, first and second electrodes 3A and 3B, a first slot 4, third and fourth electrodes 5A and 5B, a second slot 6, etc to be described later.

The dielectric substrate 2 is made of a resin material, a ceramic material, or a composite material in which the resin material and the ceramic material are mixed and sintered, and the dielectric substrate 2 is formed so as to be a flat plate having, for example, a relative dielectric constant εr of approximately 24 and a thickness dimension T of approximately 3 mm. First and second electrodes 3A and 3B, to be described later, are provided on the surface 2A of the dielectric substrate 2, and third and fourth electrodes 5A and 5B are provided on the rear face 2B of the dielectric substrate 2.

The first and second electrodes 3A and 3B face each other with a fixed space therebetween. Each of the first and second electrodes 3A and 3B is a thin film of a conductive metal material formed on the dielectric substrate 2 by sputtering, vacuum evaporation, etc.

A first slot 4 is positioned on the surface 2A of the dielectric substrate 2 and sandwiched between the first and second electrodes 3A and 3B, and the first slot 4 is a belt-shaped (or groove-shaped) opening formed so as to have a fixed width dimension W1 and extends in the transmission direction (direction of an arrow A in FIG. 1) of a high-frequency signal of microwaves and millimeter waves, etc., for example.

Third and fourth electrodes 5A and 5B are formed on the rear face 2B of the dielectric substrate 2, and the third and fourth electrodes 5A and 5B are disposed so as to face the first and second electrodes 3A and 3B with the dielectric substrate 2 sandwiched therebetween. The third and fourth electrodes 5A and 5B face each other with a fixed distance therebetween which is different from the distance between the first and second electrodes 3A and 3B. Each of the third and fourth electrode 5A and 5B is a thin film of a conductive material formed on the dielectric substrate 2 by sputtering, vacuum evaporation, etc.

A second slot 6 is positioned on the rear face 2B of the dielectric substrate 2 and sandwiched between the third and fourth electrodes 5A and 5B. The second slot 6 is disposed so as to have the center in the width direction at the same location as that of the first slot 4 and disposed at a location to face the first slot 4 with the dielectric substrate 2 sandwiched therebetween, and a belt-shaped (groove-shaped) opening is formed along the transmission direction (direction of an arrow A in FIG. 1) of a high-frequency signal. Furthermore, the second slot 6 has a fixed width dimension W2 different from the width dimension W1 of the first slot 4 and the width dimension W2 of the second slot 6 is set to be larger than the width dimension W1 (W1<W2).

A package 7 is provided above the surface 2A of the dielectric substrate 2, and the package 7 is formed by using a conductive material and mechanically and electrically connected to, for example, the first and second electrodes 3A and 3B to cover the first slot 4.

A back-side package 8 is provided above the rear face 2B of the dielectric substrate 2, and the back-side package 8 is formed in substantially the same way as the surface-side package 7 by using a conductive material and mechanically and electrically connected to, for example, the third and fourth electrodes 5A and 5B to cover the second slot 6.

A planar dielectric line according to the present embodiment has the above-described structure and the function thereof is described below.

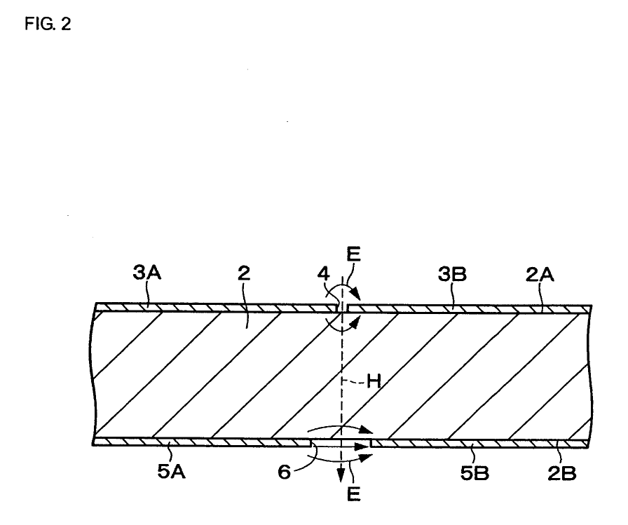

When a high-frequency signal is input to the vertically asymmetrical transmission line shown in FIG. 2, electric fields E are formed in the width direction of the first and second slots 4 and 6 and, at the same time, magnetic fields are formed in the length direction of the first and second slots 4 and 6 and in the thickness direction of the dielectric substrate 2. Then, a TE-mode electromagnetic wave (TE wave) is generated. The E plane of the TE wave is parallel with the surface 2A and the rear face 2B of the dielectric substrate 2 where the first and second slots 4 and 6 are open. The high-frequency signal is propagated along the first and second slots 4 and 6. At this time, the total reflection of the high-frequency signal is repeated at the surface 2A and rear face 2B of the dielectric substrate 2 where the first and second slots 4 and 6 are open, and the high-frequency signal is concentrated inside the dielectric substrate 2 and neighborhood thereof, and propagated.

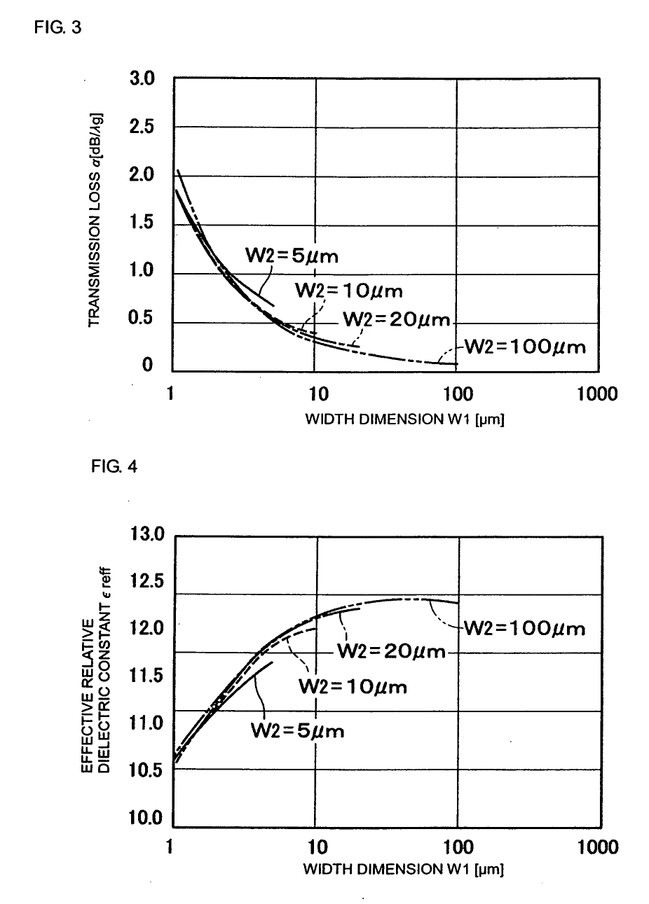

In the vertically asymmetrical transmission line 1 according to the present embodiment, since the width dimension W1 of the first slot 4 is set to be smaller than the width dimension W2 of the second slot 6 (W1<W2), the electromagnetic field energy of the high-frequency signal can be concentrated on the first slot 4 by changing each value of the width dimensions W1, W2, etc. Then, concerning a high-frequency signal of 60 GHz, for example, the transmission characteristics of a vertically asymmetrical transmission line 1 has been calculated by using the Finite Element Method or the Spectral Domain Method (the Method of Moment). The result is shown in FIGS. 3 to 8.

Moreover, as far as the conditions are not described in particular, in calculation of the transmission characteristics, the relative dielectric constant εr of the dielectric substrate 2 is 24 (εr=24) and the thickness dimension T of the dielectric substrate 2 is 0.3 mm (T=0.3 mm).

FIGS. 3 and 4 show the transmission loss α of the line and the effective relative dielectric constant εreff, respectively, when the width dimension W1 of the first slot 4 and the width dimension W2 of the second slot 6 are changed. From the result in FIGS. 3 and 4, when the width dimension W1 of the first slot 4 having a smaller width is changed, the transmission loss α and the effective relative dielectric constant εreff change. On the other hand, even if the width dimension W2 of the second slot 6 having a larger width is changed, it is understood that the transmission loss α and the effective relative dielectric constant εreff substantially does not change. Accordingly, since the transmission loss α of the line and the effective relative dielectric constant εreff are determined in accordance with the width W1 of the first slot 4, it is understood that the electromagnetic field energy of a high-frequency signal is concentrated on the first slot 4.

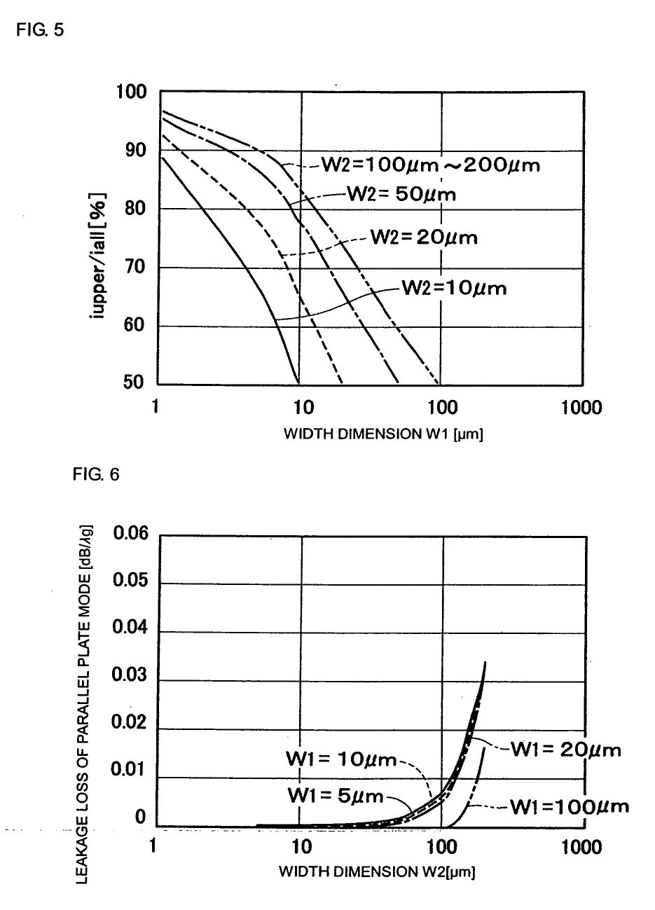

FIG. 5 shows the ratio of the current amount iupper distributed on the surface 2A of the dielectric substrate 2 to the total current amount iall when the widths W1 and W2 of the first and second slots 4 and 6 were changed. As shown in FIG. 5, it becomes possible to concentrate the current on the surface 2A of the dielectric substrate 2 by reducing the width W1 of the first slot 4. In particular, in case of W2≧100 μm, when the width W1 is made W1<10 μm, 80% or more of the total current amount iall can be concentrated on the surface 2A. Furthermore, in case of W2≧100 μm, when the width W1 is made W1<5 μm, 90% or more of the total current amount iall can be concentrated on the surface 2A.

FIG. 6 shows the leakage loss of a parallel plate mode (an unwanted mode) when the widths W1 and W2 of the first and second slots 4 and 6 are changed. As is understood from the result in FIG. 6, when the width W2 of the second slot 6 is made 100 μm or less (W2≦100 μm), it becomes possible to reduce the leakage loss of the unwanted mode.

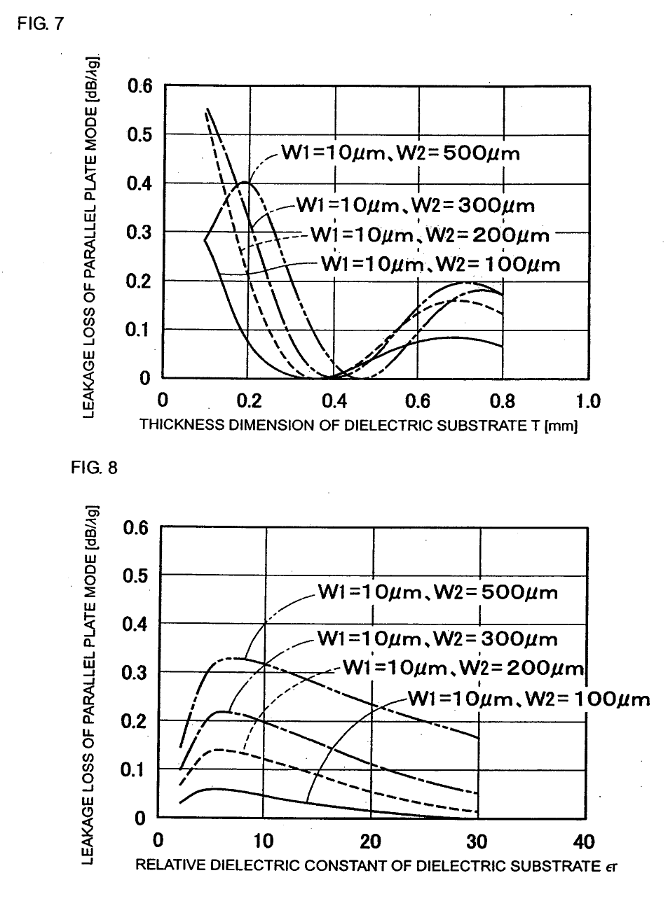

FIG. 7 shows the leakage loss of the unwanted mode when the thickness T of the dielectric substrate 2 was changed. From the result in FIG. 7, it is able to reduce the leakage loss by setting the thickness T of the dielectric substrate 2 in the range of approximately 0.3 to 0.4 mm (T≅0.3 to 0.4 mm).

FIG. 8 shows the leakage loss of the unwanted mode when the relative dielectric constant εr of the dielectric substrate 2 was changed. As shown in FIG. 8, in the range where the relative dielectric constant εr is 10 or more, as the relative dielectric constant εr increases, the leakage loss of the unwanted mode decreases. In particular, in the case where the width W1 of the first slot 4 is set at 10 μm and the width W2 of the second slot 6 is set at 100 μm, when the relative dielectric constant εr is set to be 20 or more, it is able to reduce the leakage loss of the unwanted mode in comparison with the case where the relative dielectric constant εr is set to be smaller than 20.

From the above-described result, in the 60 MHz band, when the relative dielectric constant εr of the dielectric substrate 2 is 20 or more (εr≧20), the thickness T is in the range of substantially 0.3 to 0.4 mm (T≅0.3 to 0.4 mm), the width W1 of the first slot 4 is 10 μm or less, and the width W2 of the second slot 6 is made substantially 100 μm (W2≅100 μm), it is understood that the electromagnetic field energy of a high-frequency signal is concentrated on the surface 2A of the dielectric substrate 2 and the leakage loss of the unwanted mode can be reduced. When these numerical values are normalized by using the wavelength λg0 of a high-frequency signal inside the dielectric substrate 2, it is understood that the thickness T is set to be substantially in the range of 0.3 to 0.4 λg0 (T≅0.3 to 0.4 λg0), the width W1 of the first slot 4 is to be equal to or less than λg0/10 (W1<λg0/100), and the width W2 of the second slot 6 may be set to be substantially 100 μm (W2 λg0/10). The wavelength λg0 can be expressed by the following numerical expression 1 using a frequency f of a high frequency, the relative dielectric constant ε of the dielectric substrate 2, and the speed of light c.

$$λ g 0 = \frac{c}{f \sqrt{ɛ r}} \qquad Numerical expression 1$$

Thus, in the present embodiment, since the widths W1 and W2 of the first and second slots 4 and 6 are set at different values from each other, the electromagnetic field energy of a high-frequency signal can be concentrated in the first slot 4 having a narrower width W1. Accordingly, the connection loss between the vertically asymmetrical transmission line 1 and an electronic part can be reduced by disposition of the electronic part on and near the first slot 4.

Furthermore, since the widths W1 and W2 of the first and second slots 4 and 6 have been set at different values from each other, the degree of freedom of designing each of the slots 4 and 6 can be increased in comparison with the case where the widths of two slots are set at the same value as in the related art.

In particular, in the case where the relative dielectric constant εr of the dielectric substrate 2 is 20 or more, the thickness T of the dielectric substrate 2 is substantially in the range of 0.3 to 0.4 λg0, the width W1 of the first slot 4 is λg0/100 or less, and the width W2 of the second slot 6 is set to be substantially λg0/10, 80% or more of the electromagnetic field energy of a high-frequency signal can be concentrated on the first slot 4 having a narrower width and the leakage loss of an unwanted mode can be reduced.

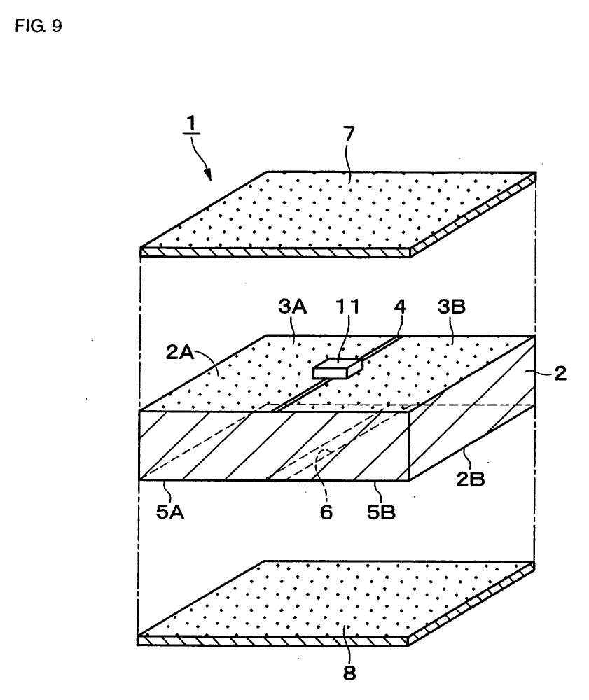

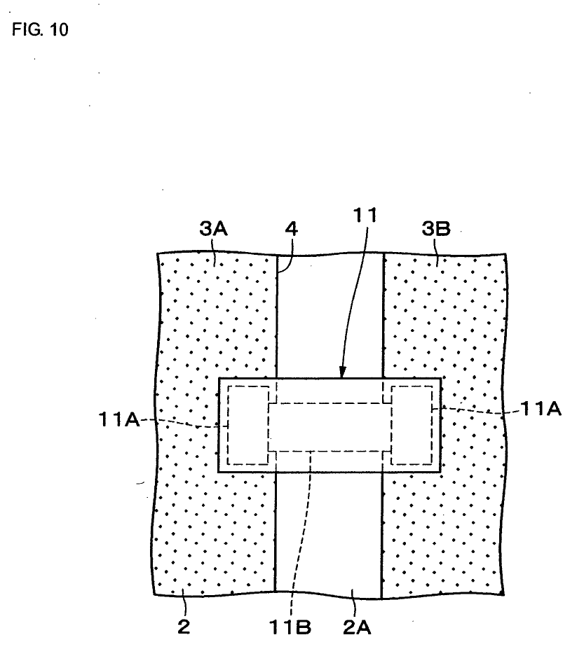

FIGS. 9 and 10 show a second embodiment of the present invention, and is characterized in that an electronic part is connected to the slot having a narrower width dimension. In the second embodiment, the same reference numeral is given to the same structure element as in the first embodiment and its description is omitted.

An electronic part 11 is connected to the first slot 4 having a narrower width W1. The electronic part 11 is, for example, a field-effect transistor (FET), a resistor, a diode, a capacitor, and is mounted so as to cross over the first slot 4. As shown in FIG. 10, the electronic part 11 contains, for example, an element main body 11A housed inside a resin package and an electrode pattern 11B connected to the element main body 11A, and the electrode pattern 11B is connected to the electrodes 3A and 3B.

Thus, in the second embodiment, a similar effect as in the first embodiment can be obtained. In particular, since the electronic part 11 is connected to the first slot 4 having a narrower width W1, the matching between the vertically asymmetrical transmission line 1 and the electronic part 11 is increased and the connection loss can be reduced. Furthermore, since the electrode pattern 11B for connection of the electronic part 11 may be disposed so as to span the first slot 4 having a narrower width W1, in comparison with the case where the electronic part 11 is connected to the electrodes 3A, 3B, 5A, and 5B on both surfaces 2A and 2B of the dielectric substrate 2, the degree of freedom of designing the electrode pattern 11B of the electronic part 11 can be increased and the degree of freedom of design of the electrodes 3A, 3B, 5A, and 5B to be connected to the electronic part 11 can be also increased.

Furthermore, since the line conversion for connection of the electronic part 11 performed in the related art is not performed in the second embodiment, a region for connection to the electronic part 11 can be reduced. Since the first and second slots 4 and 6 face each other with the dielectric substrate 2 sandwiched therebetween, the opening between the electrodes 5A and 5B (slot 6) is disposed at a location opposed to the electronic part 11. Accordingly, in comparison with the case where an electronic part is connected to a slot line in which a rear face opposing to a slot is covered by an electrode as in the related art, the second embodiment is able to suppress the generation of an unwanted mode (a parallel plate mode) inside the dielectric substrate 2 and to reduce the leakage loss of the parallel plate mode.

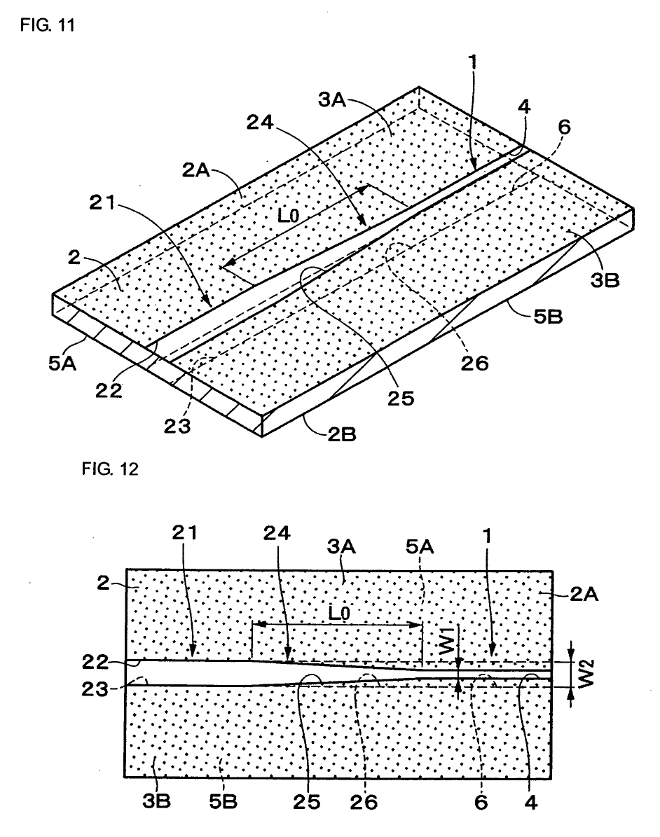

FIGS. 11 to 14 show a third embodiment of the present invention, and is characterized in that a vertically symmetrical transmission line composed of third and fourth slots having the same width is connected with a vertically asymmetrical transmission line composed of first and second slots having different widths from each other by using a tapered slot. Moreover, in the third embodiment, the same reference numeral is given to the same structure element as in the first embodiment and its description is omitted.

A vertically symmetrical transmission line 21 is disposed on the extension line of the vertically asymmetrical transmission line 1 and the vertically symmetrical transmission line 21 is composed of the dielectric substrate 2, the first to fourth electrodes 3A, 3B, 5A and 5B, third and fourth slots 22 and 23, etc.

A third slot 22 is positioned on the surface 2A of the dielectric substrate 2 and sandwiched between the first and second electrodes 3A and 3B and, in the third slot 22, a belt-shaped (groove-shaped) opening is formed along the transmission direction of a high-frequency signal. Furthermore, the width of the third slot 22 is larger than the width W1 of the first slot 4 and set to be substantially the same as the width W2 of the second slot 6.

A fourth slot 23 is positioned on the rear face 2B of the dielectric substrate 2 and sandwiched between the third and fourth electrodes 5A and 5B and, in the fourth slot 23, the center in the width direction is disposed at the same location as in the third slot 22 and disposed at a location opposite to the third slot 22 with the dielectric substrate 2 sandwiched therebetween to form a belt-shaped (groove-shaped) opening along the transmission direction of a high-frequency signal. Furthermore, the fourth slot 23 has substantially the same width as the width W2 of the second and third slots 6 and 22.

A connection line 24 is provided between the vertically asymmetrical transmission line 1 and the vertically symmetrical transmission line 21, and the connection line 24 is composed of the dielectric substrate 2, the first to fourth electrodes 3A, 3B, 5A, and 5B, a tapered slot 25, a connection slot 26, etc., to have a line length L0 extended between the line 1 and the line 21.

The tapered slot 25 is used for connecting the first and third slots 4 and 22 and, in the tapered slot 25, a tapered opening in which the width is gradually expanded (continuously expanded) from the first slot 4 having a narrower width to the third slot 22 having a wider width and the first slot 4, the tapered slot 25, and the third slot 22 are extended continuously and linearly.

The connection slot 26 is used for connecting the second and fourth slots 6 and 23, and, in the connection slot 26, a belt-shaped opening extending with substantially the same and fixed width as the second and fourth slots 6 and 23 is formed and the second slot 6, the connection slot 26, and the fourth slot 23 are extended continuously and linearly.

Thus, in the third embodiment, a similar effect as in the first embodiment can be obtained. However, in the third embodiment, since the vertically symmetrical transmission line 21 composed of the third and fourth slots 22 and 23 having the same width is connected with the vertically asymmetrical transmission line 1 composed of the first and second slots 4 and 6 having different widths from each other, the connection and matching with an electronic part can be improved using the vertically asymmetrical transmission line 1 and a high-frequency signal can be propagated with a low transmission loss by using the vertically symmetrical transmission line 21. Furthermore, since the vertically asymmetrical transmission line 1 and the vertically symmetrical transmission line 21 are connected by using the connection line 24 having the tapered slot 25 therebetween, the insertion loss between those can be reduced.

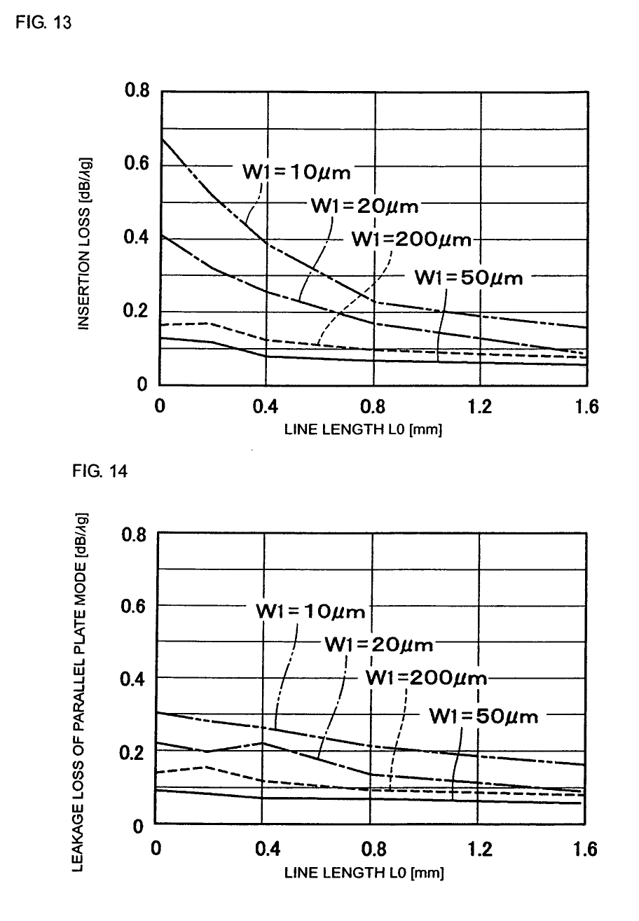

Furthermore, in order to select the line length LO of the connection line 24 (tapered slot 25), the insertion loss between the lines 1 and 21 and the leakage loss in a parallel plate mode when the line length L0 is changed were calculated by using the Spectral Domain Method, etc. The results are shown in FIGS. 13 and 14.

From the results in FIGS. 13 and 14, when the line length L0 is set substantially in the range of 0.4 to 0.8 mm (L0≅0.4 to 0.8 mm), it is understood that both the insertion loss and leakage loss largely decrease in comparison with the losses when the line length L0 is 0 mm (when the lines 1 and 21 are directly connected). On the other hand, although the insertion loss and the leakage loss further decrease even if the line length L0 is larger than 0.8 mm (L0>0.8 mm), it is understood that the efficiency of the decrease of each loss to the increase of the line length L0 is reduced.

Accordingly, when the line length L0 of the connection line 24 is set substantially in the range of 0.4 to 0.8 mm (L0≅0.4 to 0.8 mm), while the line length L0 is kept short, the insertion loss and the leakage loss can be effectively reduced. That is, in the case where it is normalized by using the wavelength λg of a high-frequency signal being propagated in the vertically asymmetrical transmission line 1, when the line length L0 of the connection line 24 is set substantially in the range of λg/4 to λg/2 (L0≅λg/4 to λg/2), the connection line 24 (tapered slot 25) is small-sized and the insertion loss and the leakage loss can be effectively reduced.

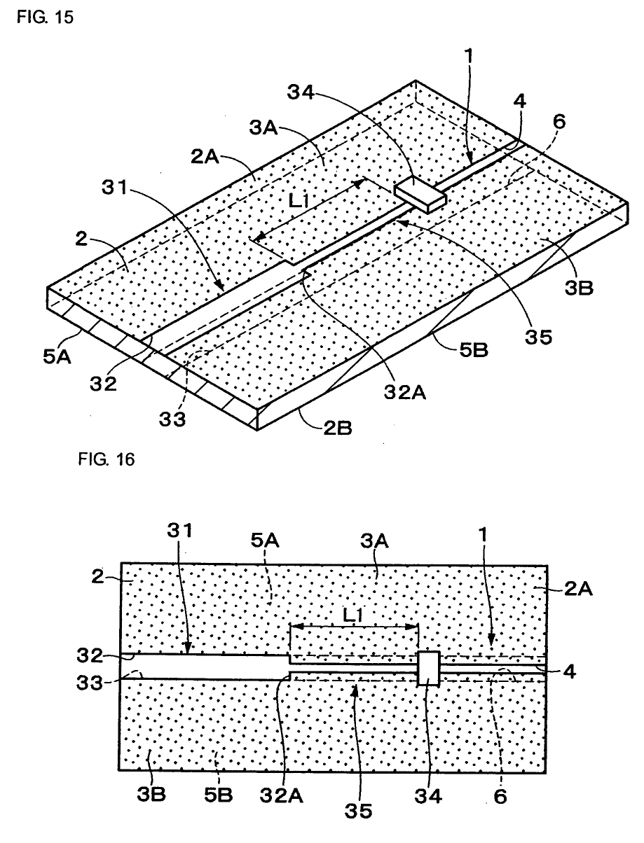

FIGS. 15 and 16 show a fourth embodiment of the present invention, and is characterized in that a vertically symmetrical transmission line composed of third and fourth slots having the same width is connected with a vertically asymmetrical transmission line composed of first and second slots having different widths from each other. An impedance matching circuit is provided between those lines. Moreover, in the fourth embodiment, the same reference numeral is given to the same structure element as in the first embodiment and its description is omitted.

A vertically symmetrical transmission line 31 is positioned on an extension line of the vertically asymmetrical transmission line 1 and directly connected to the vertically asymmetrical transmission line 1, and the vertically symmetrical transmission line 31 is composed of the dielectric substrate 2, the first to fourth electrodes 3A, 3B, 5A, and 5B, third and fourth slots 32 and 33, etc.

The third slot 32 is positioned on the surface 2A of the dielectric substrate 2 and sandwiched between the first and second electrodes 3A and 3B, and the third slot 32 has a belt-shaped opening which is larger than the width W1 of the first slot 4 and substantially the same as the width W2 of the second slot 6 and is directly connected to the first slot 4. A step-like connection point 32A is formed at the boundary between the first and third slots 4 and 32.

The fourth slot 33 is positioned on the rear face 2B of the dielectric substrate 2 and sandwiched between the third and fourth electrodes 5A and 5B, and the fourth slot 33 is disposed at a position opposite to the third slot 32 with the dielectric substrate 2 sandwiched therebetween and has substantially the same fixed width as the width W2 of the second and third slots 6 and 32.

An electronic part 34 is attached to a middle point of the vertically asymmetrical transmission line 1, and the electronic part 34 is connected to the first slot 4 having a narrower width W1 and electrode patterns of the electronic part 34 (not illustrated) are connected to the electrodes 3A and 3B.

Here, the electronic part 34 is disposed at a position separated from the connection point 32A by the line length L1 and the line length L1 is set at the value of substantially one fourth of the wavelength kg of a high-frequency signal being propagated in the vertically asymmetrical transmission line 1 (L1≅λg/4), for example. Furthermore, when the characteristic impedance of the vertically symmetrical transmission line 31 is Z1 and the characteristic impedance of the electronic part 34 seen from point 32A which is an end portion of the vertically asymmetrical transmission line 1 is made to be Z2, the characteristic impedance Zc of the vertically asymmetrical transmission line 1 is set at Zc=(Z1×Z2). In this way, a λg/4 impedance matching circuit 35 can be formed between the vertically symmetrical transmission line 31 and the electronic part 34.

Thus, in the fourth embodiment, a similar effect as in the first embodiment can be obtained. Since the vertically symmetrical transmission line 31 is connected to the vertically asymmetrical transmission line 1, the connection and matching to the electronic part 34 can be increased by using the vertically asymmetrical transmission line 1 and a high-frequency signal can be propagated with a low transmission loss by using the vertically symmetrical transmission line.

Furthermore, since the vertically symmetrical transmission line 31 is directly connected to the vertically asymmetrical transmission line 1 and the electronic part 34 is attached to a middle portion of the vertically asymmetrical transmission line 1, a λg/4 impedance matching circuit 35 can be formed between the vertically symmetrical transmission line 31 and the electronic part 34. Accordingly, by using the λg/4 impedance matching circuit 35, the insertion loss between the vertically asymmetrical transmission line 1 and the vertically symmetrical transmission line 31 can be reduced and the matching with the electronic part 34 can be improved. Moreover, in comparison with the case where the connection to a slot line is performed through a line-conversion conductor pattern and an electronic part is connected to the slot line as in the related art, a complicated line-conversion conductor pattern is not required and the space between the vertically symmetrical transmission line 31 and the electronic part 34 is shortened and, as a result, size reduction can be performed.

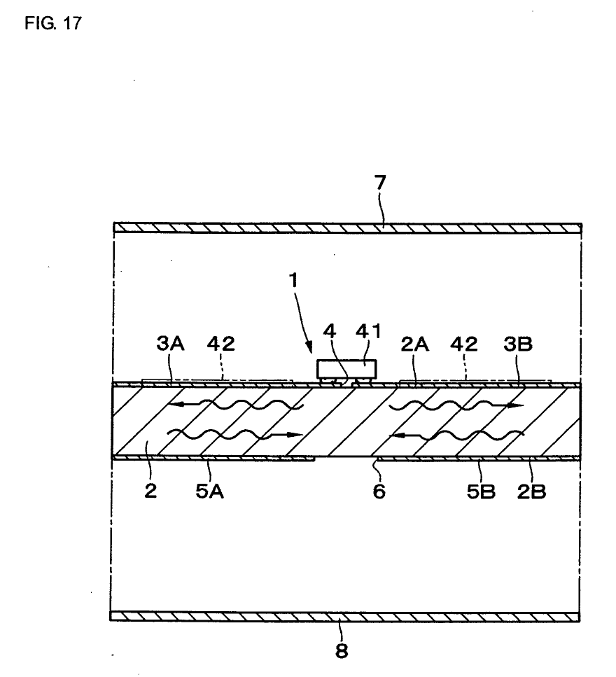

FIG. 17 shows a fifth embodiment of the present invention, and is characterized in that, in at least one of the first and second electrodes and the third and fourth electrodes, a planar-type band-stop filter is provided and positioned around the first and second slots. In the present embodiment, the same reference numeral is given to the same structure element as in the first embodiment and its description is omitted.

An electronic part 41 is attached to a middle portion of the vertically asymmetrical transmission line 1 and the electronic part 41 is connected to the first slot 4 having a narrower width W1 and electrode patterns (not illustrated) are connected to the electrodes 3A and 3B, respectively.

A planar-type band-stop filter 42 is formed in the first and second electrodes 3A and 3B, and the planar-type band-stop filter 42 is positioned around the first slot 4 and extends along the first slot 4 on both sides of the electronic part 41. The planar-type band-stop filter 42 is designed so as to have reflection characteristics in a usable frequency band of a high-frequency signal.

Although the planar-type band-stop filter 42 is shown only on the electrodes 3A and 3B on the surface 2A of the dielectric substrate 2 in the above embodiment, the planar-type band-stop filter 42 may also be provided only on the electrodes 5A and 5B on the rear face 2B, or may be provided on the electrodes 3A, 3B, 5A, and 5B on both surfaces 2A and 2B.

Thus, in the fifth embodiment, a similar effect as in the first embodiment can be obtained. Since the planar-type band-stop filter 42 is provided on the first and second electrodes 3A and 3B so as to be positioned around the first and second slots 4 and 6, a parallel plate mode electromagnetic wave leaking (spreading) from the first and second slots 4 and 6 can be reflected by using the planar-type band-stop filter 42.

In particular, in the vertically asymmetrical transmission line 1, since the widths of the first and second slots 4 and 6 are different from each other, a parallel plate mode (an unwanted mode) electromagnetic wave is easily generated inside the dielectric substrate 2. However, it is possible to prevent a parallel plate mode from spreading to the surrounding area from the first and second slots 4 and 6 by using the planar-type band-stop filter 42, and then the leakage loss of a parallel plate mode can be suppressed. As a result, since the electromagnetic field energy of a high-frequency signal can be concentrated around the first and second slots 4 and 6 by suppressing the leakage of a parallel plate mode in the direction of the line width, even if a plurality of lines is provided close to each other, an unwanted electromagnetic interference between neighboring lines is reduced and the reliability can be increased.

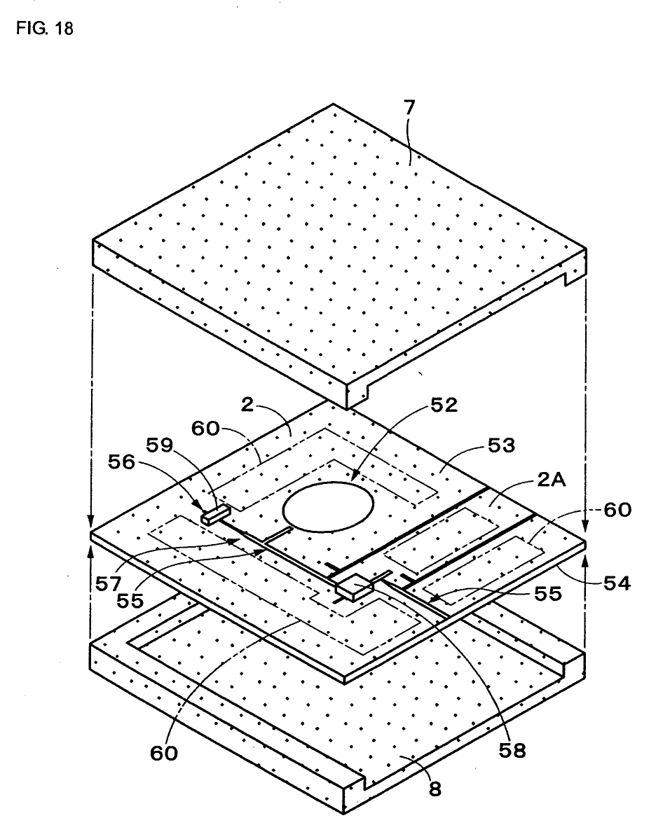

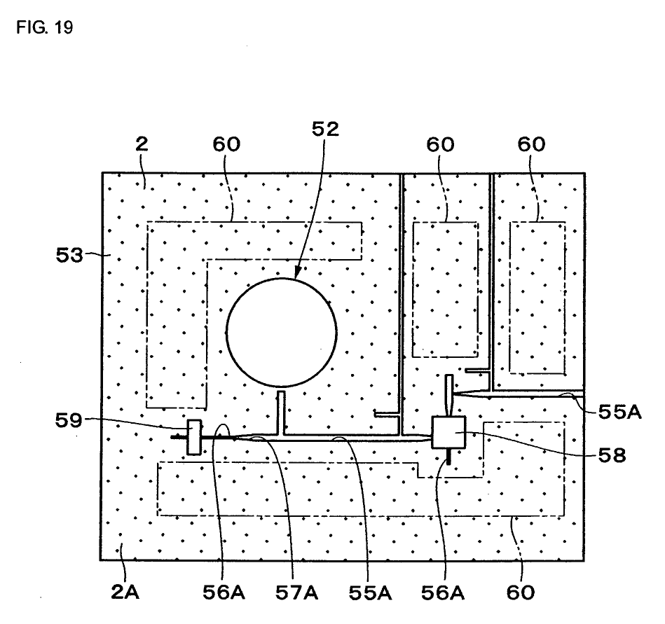

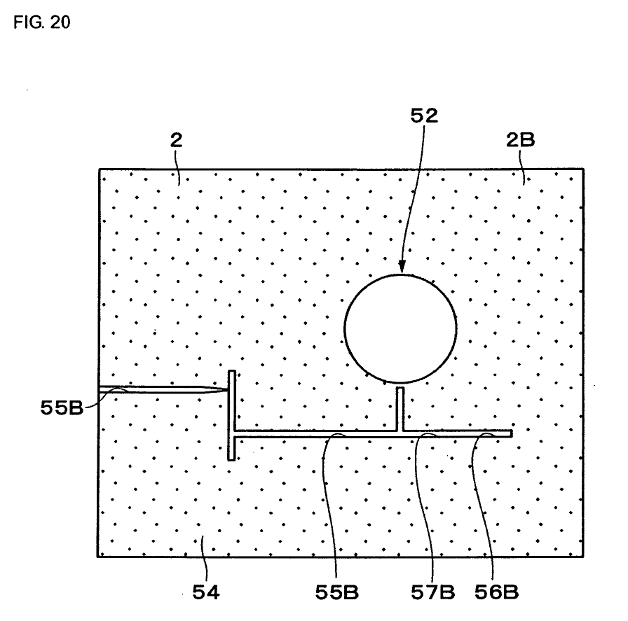

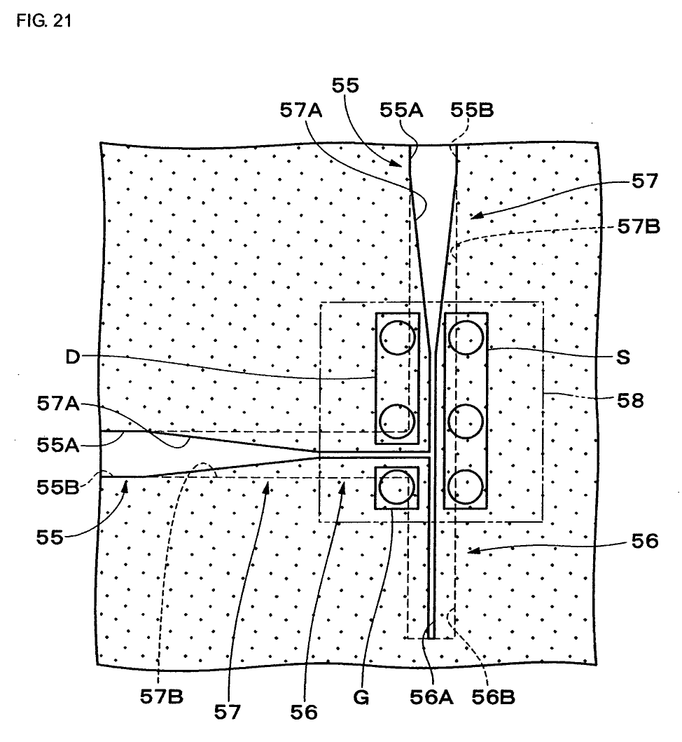

FIGS. 18 to 21 show a sixth embodiment of the present invention and is characterized in that an oscillation circuit as a high-frequency active circuit is formed by using a vertically asymmetrical transmission line. In the sixth embodiment, the same reference numeral is given to the same structure element as in the first embodiment and its description is omitted.

The oscillation circuit 51 is composed of a dielectric resonator 52, an FET 58, a terminating resistor 59, etc., to be described later.

A dielectric resonator 52 is provided in the dielectric substrate 2 and the dielectric resonator 52 is constructed in such a way that circular openings facing each other are provided in electrodes 53, 54 formed in both surfaces 2a and 2B of the dielectric substrate 2. In the dielectric resonator 52, the diameter of the opening is set in accordance with the resonance frequency f0.

A vertically symmetrical transmission line 55 is connected to the dielectric resonator 52, etc., and the vertically symmetrical transmission line 55 is composed of slots 55A and 55B having the same width provided on both surfaces 2A and 2B of the dielectric substrate 2, etc., substantially in the same way as in the vertically symmetrical transmission line 21 according to the third embodiment.

A vertically asymmetrical transmission line 56 is connected to the vertically symmetrical transmission line 55 and the vertically asymmetrical transmission line 56 is composed of slots 56A and 56B having different widths from each other provided on both surfaces 2A and 2B of the dielectric substrate 2, etc., substantially in the same way as in the vertically asymmetrical transmission line 1 according to the first embodiment, and the slot 56A on the surface side has a narrower width than the slot 56B on the rear face.

Furthermore, the vertically asymmetrical transmission line 56 is connected to the vertically symmetrical transmission line 55 by using substantially the same connection line 57 as the connection line 24 according to the third embodiment, for example. Then, the connection line 57 is composed of a tapered slot 57A provided on the surface 2A and a linear connection slot 57B provided on the rear face 2B.

A field-effect transistor 58 (hereinafter, referred to as an FET) is connected to the vertically asymmetrical transmission line 56 and, in the EFT 58, the gate terminal G, the drain terminal D, and the source terminal S are connected to the electrode 53 on the surface 2A of the dielectric substrate 2. The FET 58 is connected to the dielectric resonator 52 through the vertically asymmetrical transmission line 56 and the vertically symmetrical transmission line 55 to amplify a high frequency signal of a resonance frequency f0.

A terminating resistor 59 is connected to the vertically asymmetrical transmission line 56 and the terminating resistor 59 is connected to the electrode 53 on the surface 2A of the dielectric substrate 2 so as to cross the slot 56A.

The oscillation circuit 51 according to the sixth embodiment has the above-described structure. A band-reflection type filter having dielectric resonator 52, the terminating resistor 59, etc., inputs a signal in accordance with a resonance frequency f0 to the FET 58 and the FET 58 amplifies the high-frequency signal to output the signal to the outside through the vertically symmetrical transmission line 55, etc.

A planar-type band-stop filter 60 is formed in the electrode 53 and the planar-type band-stop filter is positioned around the transmission lines 55 and 56, etc., to enclose the FET 58, the transmission lines 55 and 56, etc., to enclose the FET 58, the terminating resistor 59, etc. The planar-type band-stop filter 60 is designed to have reflection characteristics in a using frequency band of a high-frequency signal.

Thus, in the sixth embodiment, a similar effect as in the first and third embodiments can be obtained. However, since the vertically asymmetrical transmission line 56 is connected to the FET 58 and the terminating resistor 59 to form the oscillation circuit 51, the matching to the FET 58 and the terminating resistor 59 can be increased and the gain and output power can be increased. Furthermore, since the dielectric resonator 52 and the FET 58 can be connected so as to have a good matching therebetween by using the vertically asymmetrical transmission line 56, etc., it is able to increase the load Q (QL) of the oscillation circuit 51 and to reduce phase noise. Moreover, since the connection electrode patterns of the FET 58 and the terminating resistor 59 may be disposed so as to bridge the slot 56A having a narrow width, the degree of freedom of design of the connection patterns of the FET 58, etc., can be increased.

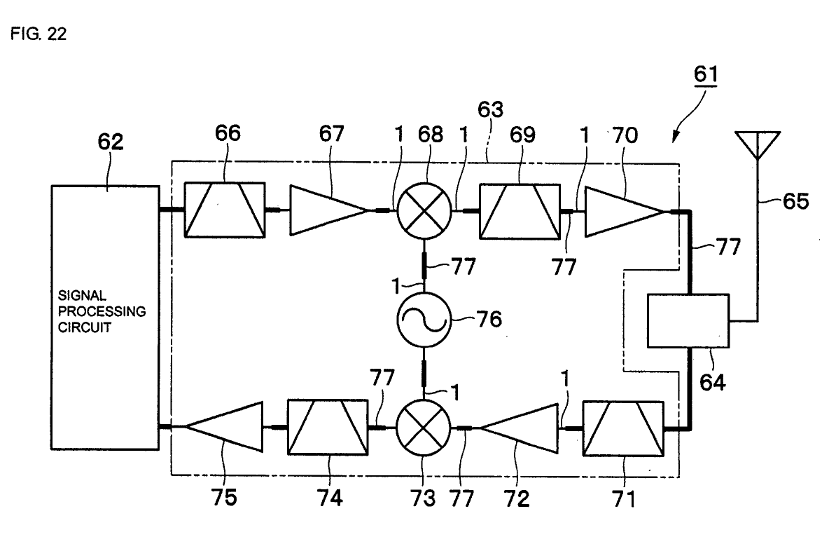

FIG. 22 shows a seventh embodiment and is characterized in that a communication device as a transmitter-receiver is formed using a vertically asymmetrical transmission line according to the present invention. Moreover, in the seventh embodiment, the same reference numeral is given to the same structure element as in the first embodiment and its description is omitted.

The communication device 61 contains a signal processing circuit 62 and a high-frequency active circuit 63 connected to the signal processing circuit 62 for transmitting and receiving a high-frequency signal. The high-frequency active circuit 63 is connected to an antenna 65 through an antenna-sharing device 64.

Furthermore, on the transmission side of the high-frequency active circuit 63, a bandpass filter 66, an amplifier 67, a mixer 68, a bandpass filter 69, and a power amplifier 70 are connected in series between the signal processing circuit 62 and the antenna-sharing device 64. On the reception side of the high-frequency active circuit 63, a bandpass filter 71, a low-noise amplifier 72, a mixer 73, a bandpass filter 74, and an amplifier 75 are connected in series between the antenna-sharing device 64 and the signal processing device 62. An oscillation circuit 76 which is substantially the same as the oscillation circuit 51 according to the sixth embodiment, for example, is connected to the mixers 68 and 73.

A vertically symmetrical transmission line 77 is connected to the amplifier 67, etc., and the vertically symmetrical transmission line 77 is constructed substantially in the same way as the vertically symmetrical transmission line 21 according to the third embodiment. The connection portion to the electronic parts of the amplifiers 67, 70, 72, and 75, the mixers 68 and 73, etc., is connected by using the vertically asymmetrical transmission line 1.

The communication device 61 according to the seventh embodiment has the above-described structure. Next, the function is described.

During transmission, an intermediate-frequency signal (IF signal) output from the signal processing circuit 62 is amplified by the amplifier 67, after unwanted signals have been removed by the bandpass filter 66, and input to the mixer 68. At this time, the intermediate-frequency signal and a carrier wave from the oscillation circuit 76 are mixed in the mixer 68 and up-converted to a high-frequency signal (RF signal). Then, the high-frequency signal output from the mixer 68 is amplified to a transmitter power by the power amplifier 70 after unwanted signals have been removed by the bandpass filter 69 and then, the signal is transmitted from the antenna 65 through the antenna-sharing device 64.

During reception, a high-frequency signal received from the antenna 65 is input to the bandpass filter 71 through the antenna-sharing device 64. Thus, the high-frequency signal is amplified by the low-noise amplifier 72 after unwanted signals have been removed by the bandpass filter 71 and then, the signal is input to the mixer 71. At this time, the high-frequency signal and a carrier wave from the oscillator circuit 76 are mixed in the mixer 73 and down-converted to an intermediate-frequency signal. Then, the intermediate-frequency signal output from the mixer 73 is amplified by the amplifier 75 after unwanted signals have been removed by the bandpass filter 74 and then, the signal is input to the signal processing circuit 62.

Thus, according to the seventh embodiment, since the communication device 61 is formed using a vertically asymmetrical transmission line 1, the matching to the amplifiers 67, 70, 72, and 75, etc., can be improved, the loss of the whole communication device 61 can be reduced, the power consumption can be reduced by increasing the power efficiency, and the communication quality can be improved.

Moreover, in the seventh embodiment, although the case in which a vertically asymmetrical transmission line of the present invention is applied to a communication device 61 as a transmitter-receiver is described as an example, the vertically asymmetrical transmission line 1 may be applied to a radar device as another transmitter-receiver.

1. A planar dielectric line comprising:
a dielectric substrate;
first and second electrodes positioned on the a first surface of the dielectric substrate to form a first slot between the first and second electrodes; and
third and fourth electrodes positioned on the a second surface of the dielectric substrate opposite the first surface to form a second slot between the third and fourth electrodes, the second slot facing the first slot,
wherein a width of the first slot and a width of the second slot are different from each other.

2. The planar dielectric line as claimed in claim 1, wherein, when a relative dielectric constant εr of the dielectric substrate is 20 or more and a wavelength of a high-frequency signal in the dielectric substrate is represented by λg0, a thickness of the dielectric substrate is substantially in the range of 0.3 to 0.4 λg0, the width of one of the first and second slots is λg0/100 or less, and the width of the other slot substantially λg0/10.

3. The planar dielectric line as claimed in claim 1, wherein an electronic part is connected to one of the first and second slots having a narrower width.

4. The planar dielectric line as claimed in claim 1 further comprising:
a third slot provided on the dielectric substrate, positioned on one end of the first slot and sandwiched between the first and second electrodes; and
a fourth slot provided on the dielectric substrate, positioned on one end of the second slot, sandwiched between the third and fourth electrodes, facing the third slot, and having the same width dimension as the third slot,
wherein the first and third slots are connected by a tapered slot having a width dimension that gradually changes.

5. The planar dielectric line as claimed in claim 4, wherein, when a wavelength of a high-frequency signal being propagated along the first and second slots is represented by λg, a line length of the tapered slot is substantially in the range of λg/4 to λg/2.

6. The planar dielectric line as claimed in claim 1 further comprising:
a third slot provided on the dielectric substrate, positioned on one end of the first slot and sandwiched between the first and second electrodes; and
a fourth slot provided on the dielectric substrate, positioned on one end of the second slot, sandwiched between the third and fourth electrodes, facing the third slot, and having the same width dimension as the third slot,
wherein the first and third slots are directly connected and the second and fourth slots are directly connected so as to form an impedance matching circuit.

7. The planar dielectric line as claimed in claim 1, further comprising a planar-type band-stop filter provided around at least one of the first and second slots.

8. A high-frequency active circuit comprising a planar dielectric line as claimed in claim 1.

9. A transmitter-receiver comprising a planar dielectric line as claimed in claim 1.

10. The planar dielectric line as claimed in claim 1, wherein a relative dielectric constant εr of the dielectric substrate is 20 or more.

11. The planar dielectric line as claimed in claim 1, wherein a wavelength of a high-frequency signal in the dielectric substrate is represented by λg0, and a thickness of the dielectric substrate is substantially in the range of 0.3 to 0.4 λg0.

12. The planar dielectric line as claimed in claim 1, wherein a wavelength of a high-frequency signal in the dielectric substrate is represented by λg0, and the width of one of the first and second slots is λg0/100 or less, and the width of the other slot is substantially λg0/10.
